(19) United States
(12) Patent Application Publication
(10) Pub. No.: US 2024/0301897 A1
(43) Pub. Date: Sep. 12, 2024

(54) MULTI-POUCH INFLATABLE SOFT ACTUATORS

(71) Applicant: Toyota Motor Engineering & Manufacturing North America, Inc., Plano, TX (US)

(72) Inventors: Yuyang Song, Ann Arbor, MI (US); Umesh N. Gandhi, Farmington Hills, MI (US); Danil V. Prokhorov, Canton, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/118,254

(22) Filed: Mar. 7, 2023

(51) Int. Cl. F15B 15/20; F15B 11/20

(52) U.S. Cl. CPC F15B 15/20; B25J 9/142

(57) ABSTRACT

A soft actuator includes an inflatable arm having a plurality of inflatable pouches, a common fluid channel in fluid communication with and configured to provide a pressurized fluid to the plurality of inflatable pouches, a plurality of valves in fluid communication with the common fluid channel and the plurality of inflatable pouches. At least one sensor in communication with at least one of the plurality of inflatable pouches is include and the common fluid channel, the plurality of valves and the at least one sensor are configured to selectively inflate the plurality of inflatable pouches.

### TECHNICAL FIELD

The present disclosure relates generally to soft actuators, and particularly to soft actuators with pouches.

### BACKGROUND

Actuators are ubiquitous building blocks of modern society, spanning industries such as automotive, aeronautics, and robotics. And unlike traditional actuators typically made from heavy and/or rigid materials that limit power density of the actuators, soft actuators are made of pliable, flexible materials and as such can exhibited enhanced power density. However, soft actuators can have limited degrees of freedom with respect to movement and/or deployment.

The present disclosure addresses issues related to the movement and/or deployment of soft actuators along with other issues related to soft actuators.

### SUMMARY

This section provides a general summary of the disclosure and is not a comprehensive disclosure of its full scope or all of its features.

In one form of the present disclosure, a soft actuator includes an inflatable arm having a plurality of inflatable pouches, a common fluid channel in fluid communication with and configured to provide a pressurized fluid to the plurality of inflatable pouches, a plurality of valves in fluid communication with the common fluid channel and the plurality of inflatable pouches. At least one sensor in communication with at least one of the plurality of inflatable pouches is include and the common fluid channel, the plurality of valves and the at least one sensor are configured to selectively inflate the plurality of inflatable pouches.

In another form of the present disclosure, a soft actuator includes an inflatable arm and a controller. The inflatable arm includes a plurality of inflatable pouches and a common fluid channel in fluid communication with and configured to provide a pressurized fluid to the plurality of inflatable pouches. A plurality of valves in fluid communication with the common fluid channel and the plurality of inflatable pouches, and a plurality of sensors sensor in communication with at least a subset of the plurality of inflatable pouches are included. The common fluid channel, the plurality of valves and the plurality of sensors are configured to selectively inflate the plurality of inflatable pouches, and the controller is configured to command the plurality of valves such that the plurality of inflatable pouches are selectively inflated.

In still another form of the present disclosure, a soft actuator includes an inflatable arm, an inflation device, and a controller. The inflatable arm includes a plurality of inflatable pouches and a common fluid channel in fluid communication with and configured to provide a pressurized fluid to the plurality of inflatable pouches. A plurality of valves in fluid communication with the common fluid channel and the plurality of inflatable pouches, and a plurality of sensors sensor in communication with at least a subset of the plurality of inflatable pouches are also included. The common fluid channel, the plurality of valves and the plurality of sensors are configured to selectively inflate the plurality of inflatable pouches, the inflation device is in fluid communication with and configured to provide a pressurized fluid to the common fluid channel, and the controller is configured to command the plurality of valves such that the plurality of inflatable pouches are selectively inflated.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1A shows a perspective view of a soft actuator according to one form of the present disclosure;

FIG. 1B shows a side cross-sectional view of the soft actuator in FIG. 1B;

FIG. 2A shows a side view of the soft actuator in FIG. 1A in an uninflated state according to the teachings of the present disclosure;

FIG. 2B shows a side view of the soft actuator in FIG. 1A in an inflated state according to the teachings of the present disclosure;

FIG. 3 shows a side cross-sectional view of a soft actuator according to another form of the present disclosure;

FIG. 4A shows a side view of the soft actuator in FIG. 3 in an uninflated state according to the teachings of the present disclosure;

FIG. 4B shows a side view of the soft actuator in FIG. 3 in an inflated state according to the teachings of the present disclosure;

FIG. 5 shows a side cross-sectional view of a soft actuator according to still another form of the present disclosure;

FIG. 6A shows a side view of the soft actuator in FIG. 5 in an uninflated state according to the teachings of the present disclosure;

FIG. 6B shows a side view of the soft actuator in FIG. 5 in an inflated state according to the teachings of the present disclosure;

FIG. 7 is a block diagram for a soft actuator according to the teachings of the present disclosure; and

FIG. 8 is a flow chart for a method of using a soft actuator according to the teachings of the present disclosure.

It should be noted that the figures set forth herein are intended to exemplify the general characteristics of the methods, algorithms, devices, and systems among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides a soft actuator with a plurality of inflatable pouches (also referred to herein simply as “pouches”) that can be, and are, selectively inflated. The pouches are attached to a pouch holder and a common fluid channel (also referred to herein simply as a “fluid channel”) is in communication with and configured to provide a fluid (e.g., a gas or a liquid) to, and thereby inflate, the pouches. In some variations, the fluid channel is included as part of the pouch holder, while in other variations the fluid channel is separate from the pouch holder. In at least one variation, all of the pouches individually include a valve such that each pouch can be, and is, independently inflated. In other variations, a subset of the pouches individually include a valve such that the subset of pouches can be, and are, inflated independently of each other. Accordingly, the soft actuator includes pouches that can be independently and selectively inflated with a fluid as desired.

In some variations, the soft actuator includes one or more sensors. For example, in at least one variation the soft actuator includes a load sensor configured to detect a load supported, or to be supported, by the soft actuator. In the alternative, or in addition to, the soft actuator includes one or more pressure sensors configured to determine pressure(s) within one or more of the pouches. And a controller in communication with the one or more sensors and the one or more valves can be included such that an inflating device selectively provides a pressurized fluid to one or more of the pouches.

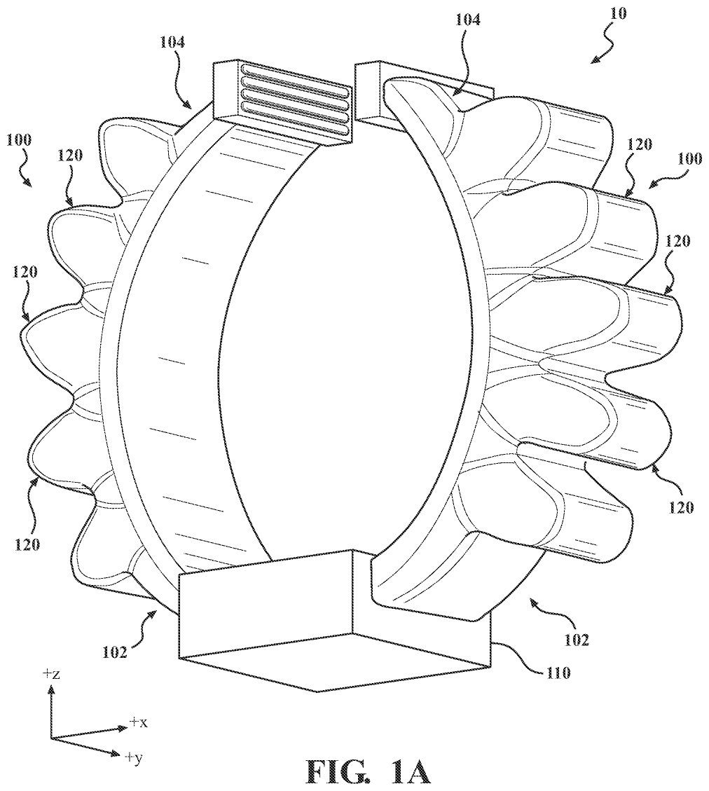

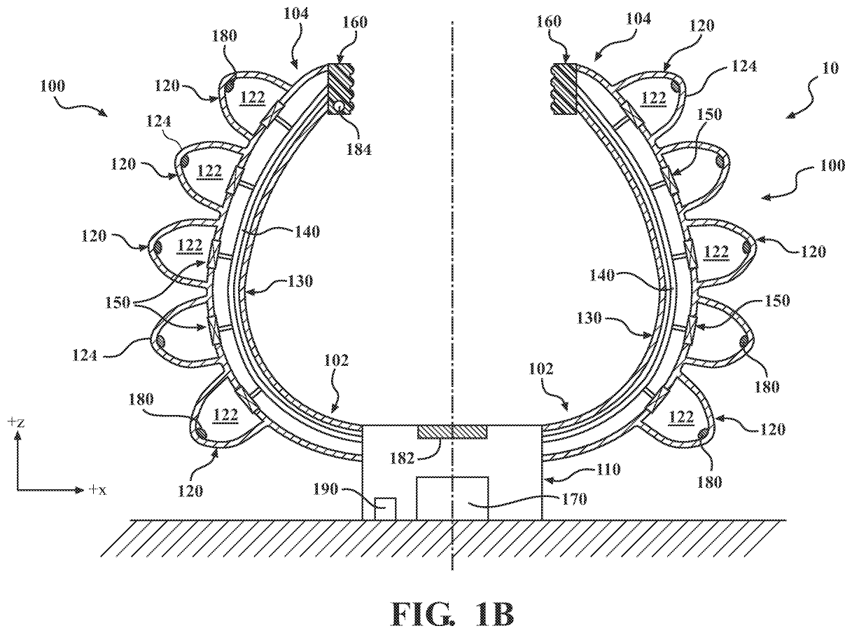

Referring to FIGS. 1A-1B, a soft actuator 10 according to one form of the present disclosure includes one or more actuator arms 100 and a base structure 110 (also referred to herein simply as “base 110”). Each actuator arm 100 includes a proximal end 102 (FIG. 1B) attached to and/or supported by the base 110, a distal end 104 (FIG. 1B) spaced apart from the proximal end 102, and a plurality of pouches 120 extending between the proximal end 102 and the distal end 104. Each of the pouches 120 includes an interior 122 at least partially defined by a pouch wall 124 and, in some variations, the pouches 120 are attached to and supported by a pouch holder 130 having a fluid channel 140 in fluid communication with the pouches 120. In other variations, the pouches 120 are attached to and supported by the pouch holder 130 and the fluid channel 140 extends is not within and/or attached to the pouch holder 130 (not shown).

In some variations, the fluid channel 140 is in fluid communication with one or more of the pouches 120 via a plurality of valves 150 (FIG. 1B) configured to move or operate between a closed position such that fluid does not flow through the valve 150 and an open position such that fluid does flow through the valve 150. That is, fluid flows from the fluid channel 140 into a given pouch 120 through a valve 150 when the valve 150 is in an open position. And while FIG. 1B illustrates a valve disposed between each of the pouches 120 and one of the fluid channels 140, in some variations, valves 150 are disposed between only a portion (i.e., a subset) of the pouches 120 and one of the fluid channels 140. And in such variations, only a subset of the pouches 120 with the valves 150 are configured to be selectively inflated while the remaining pouches 120 (i.e., the pouches 120 not in the subset of pouches 120) are configured to be collectively inflated.

Still referring to FIGS. 1A-1B, in some variations the soft actuator 10 includes at least one gripper 160, an inflating device 170, one or more pressure sensors 180, one or more load sensors 182, and/or a controller 190. For example, the distal end 104 of one or both of the actuator arms 100 can include and/or have a gripper 160 configured to grasp or apply pressure to an object to be moved by the soft actuator 10 as described in greater detail below. The inflating device 170 (e.g., a pump) is in fluid communication with and configured to provide pressurized fluid (e.g., air at a pressure greater than 14.7 psi (101.3 kPa)) to the fluid channel 140. The one or more pressure sensors 180 are configured to detect a pressure and transmit a pressure sensor signal (also referred to herein as a “pressure signal”) to the controller 190, and the one or more load sensors 182 are configured to detect a load and transmit a load sensor signal to the controller 190. Also, the controller 190 is configured to receive a pressure sensor signal transmitted from the one or more pressure sensors 180, receive a load sensor signal transmitted from the one or more load sensors 182, command one or more of the valves 150 to move from a closed position to an open position and vice-versa, and/or command the inflating device 170 to provide, and/or to stop providing, pressurized fluid to the fluid channel 140. In this manner, the soft actuator 10 and/or the controller 190 are configured to selectively inflate and/or selectively deflate the pouches 120 to a desired pressure.

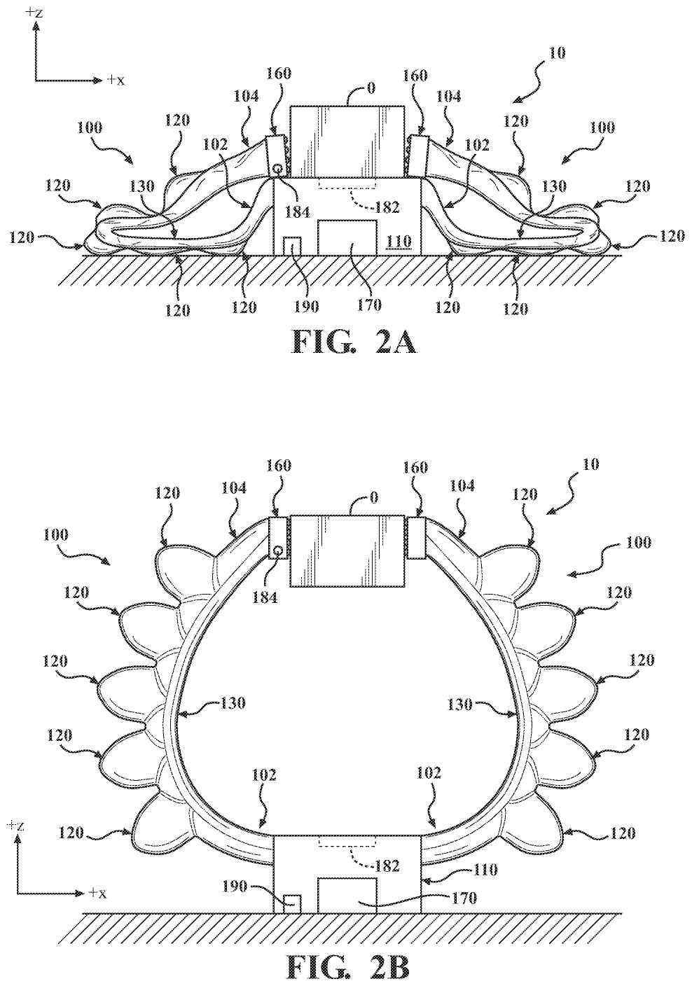

Referring to FIGS. 2A-2B, one example of the soft actuator 10 during operation is shown. Particularly, an object ‘O’ in a first position is shown in FIG. 2A and the object O lifted to a desired second position is shown in FIG. 2B. In the first position, the object is located on the base 110 and the actuator arms 100 are in a generally uninflated state. In addition, the object is positioned on the load sensor 182, and the load sensor 182 transmits a signal proportional to the mass or weight of the object O to the controller 190. The controller 190 receives input (e.g., from an individual, another sensors, and/or another controller) regarding the desired second position and receives the transmitted signal from the load sensor 182. In some variations, the controller 190 uses the input and transmitted load signal to determine (e.g., via a look up table and/or algorithm) which of the pouches 120 to be inflated and/or to want extent (e.g., pressure) the pouches 120 are to be inflated in order to move the object O from the first position to the desired second position above (+z direction) the first position. And in at least one variation, the controller 190 then commands the inflating device 170 to provide pressurized fluid to the fluid channel 140 and commands selected valves 150 to be in an open position or in a closed position such that desired pouches 120 are selectively inflated to a desired pressure and the object O is lifted from the first position to the desired second position. And in some variations a position sensor 184 configured to provide a position signal of a predefined location of one or both of the actuator arms 100 (e.g., a position of one of the grippers 160) to the controller 190 is included such that a current position of the object O is determined and/or monitored. For example, in such variations the controller 190 is configured to receive the position signal from the position sensor 184 and command the inflating device 170 and/or one or more of the valves 150 such that the object O is lifted to a desired height and/or maintained at the desired height.

In some variations, the design, shape, and/or structure of the soft actuator 10 is such that the grippers 160 are in contact with the object O in the first position (FIG. 1A). In other variations, the design, shape, and/or structure of the soft actuator 10 is such that the grippers 160 are brought into contact with the object O during pumping of the fluid into the fluid channel 140 such that the distal ends 104 with the grippers 160 move towards (+/−directions) each other. In the alternative, or in addition to, the design, shape, and/or structure of the soft actuator 10 is such that the grippers 160 are brought into contact with the object O during pumping of the fluid into one or more of the pouches 120 such that the distal ends 104 with the grippers 160 move towards each other. And while FIG. 2A illustrates the object O positioned directly on the base 110, in some variations the object O is positioned above (i.e., spaced apart from) the base 110 before being grasped by the grippers 160. For example, the object O can be held or positioned by an individual or a machine at a predefined distance above (+z direction) the base 110 before being grasped by the grippers 160. In addition, in some variations the soft actuator 10 includes only one actuator arm 100 with a mechanical, electrical and/or electro-mechanical attachment device (e.g., a hook, latch, and/or a magnet) to grasp and lift the object O, or more than two actuator arms 100 to grasp and lift the object O.

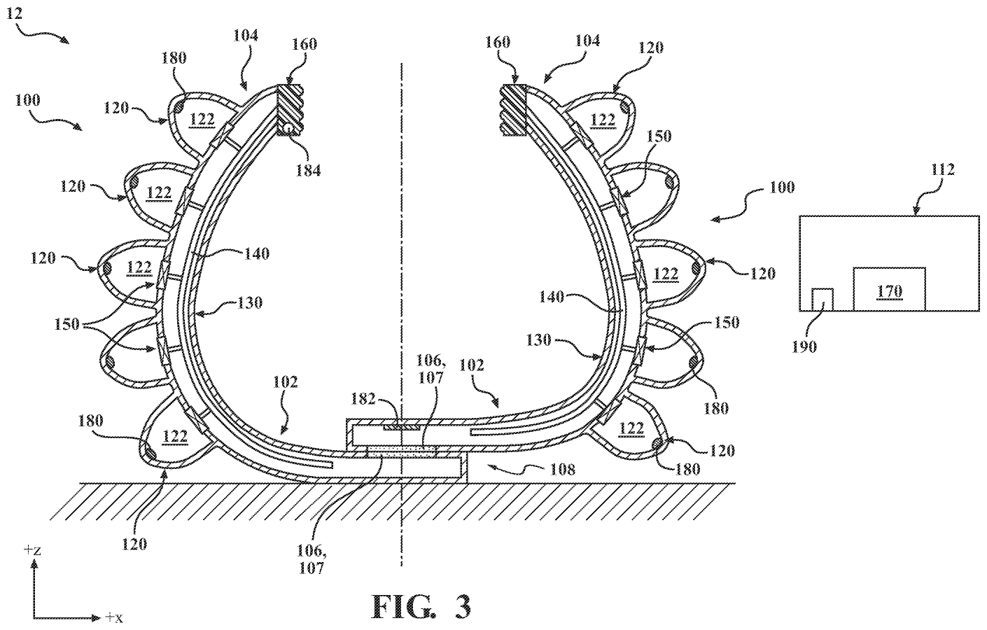

Referring now to FIG. 3, a soft actuator 12 according to another form of the present disclosure includes the actuator arms 100 as described above and included here by reference, but not repeated. However, instead of the proximal ends 102 of actuator arms 100 being attached to and/or supported by the base 110, the proximal ends 102 are coupled to and/or interlocked with each other as illustrated in the figure. For example, in some variations, each of the proximal ends 102 include a magnet 106 and/or a magnetic fabric 107 that attract each other and proximal ends 102 overlap each other such that the proximal ends 102 are interlocked together and form a base 108 (without the base 110). And in such variations, the inflating device 170 which is in communication with the fluid channel 140, and/or the controller 190 which is in communication with the valves 150, the inflating device 170, and the sensors 180, 182, 184, can be located or positioned spaced apart from the base 108 as illustrated in the figure. That is, the proximal ends 102 shown in FIG. 3 are securely interlocked with each other and positioned relative to the surface ‘S’, and do not appreciably move during operation of the soft actuator 12. In the alternative, the base 108 can be positioned on the base 110 (not shown).

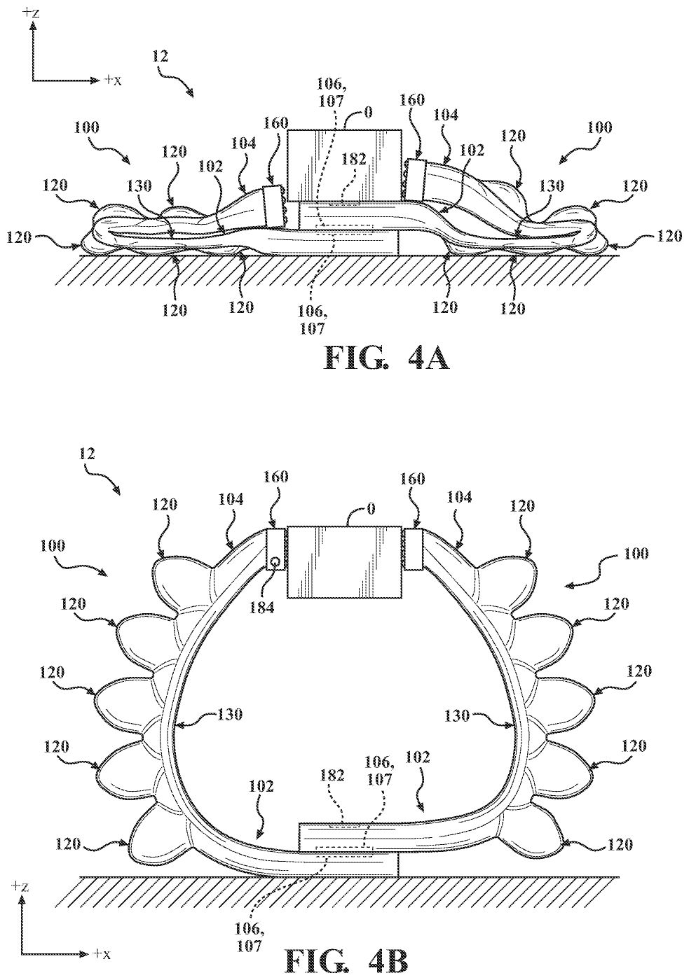

Referring to FIGS. 4A-4B, one example of the soft actuator 12 during operation is shown. Particularly, the object O in a first position is shown in FIG. 4A and the object O lifted to a desired second position is shown in FIG. 4B. In the first position, the object is located on the base 108 and the actuator arms 100 are in a generally uninflated state. In addition, the object is positioned on the load sensor 182, and the load sensor 182 transmits a signal proportional to the mass or weight of the object O to the controller 190 (FIG. 3). The controller 190 receives input (e.g., from an individual, another sensors, and/or another controller) regarding the desired second position, receives the transmitted signal from the load sensor 182, and then determines (e.g., via a look up table and/or algorithm) which of the pouches 120 to be inflated and/or to want extent (e.g., pressure) the pouches 120 are to be inflated in order to move the object O from the first position to the desired second position above (+z direction) the first position. The controller 190 also commands the inflating device 170 (FIG. 3) to provide pressurized fluid to the fluid channel 140 and commands selected valves 150 to be in an open position or in a closed position such that the pouches 120 are selectively inflated and/or deflated to a desired pressure and the object O is lifted from the first position to the desired second position. And in some variations a position sensor 184 configured to provide a position signal of a predefined location of one or both of the actuator arms 100 (e.g., a position of one of the grippers 160) to the controller 190 is included such that a current position of the object O is determined and/or monitored. For example, in such variations the controller 190 is configured to receive the position signal from the position sensor 184 and command the inflating device 170 and/or one or more of the valves 150 such that the pouches 120 are selectively inflated and/or deflated to a desired pressure and the object O is lifted to a desired height and/or maintained at the desired height.

In some variations, the design, shape, and/or structure of the soft actuator 10 is such that the grippers 160 are in contact with the object O is in the first position. In other variations, the design, shape, and/or structure of the soft actuator 10 is such that the grippers 160 are brought into contact with the object O during pumping of the fluid into the fluid channel 140 such that the distal ends 104 with the grippers 160 move towards (+/−directions) each other. In the alternative, or in addition to, the design, shape, and/or structure of the soft actuator 10 is such that the grippers 160 are brought into contact with the object O during pumping the fluid into one or more of the pouches 120 such that the distal ends 104 with the grippers 160 move towards each other. And while FIG. 2A illustrates the object O positioned directly on the base 108, in some variations the object O is positioned above (i.e., spaced apart from) the base 108 before being grasped by the grippers 160. For example, the object O can be held or positioned by an individual or a machine at a predefined distance above (+z direction) the base 108 before being grasped by the grippers 160. In addition, in some variations the soft actuator 12 includes only one actuator arm 100 with a mechanical, electrical and/or electro-mechanical attachment device (e.g., a hook, latch, and/or a magnet) to grasp and lift the object O, or more than two actuator arms 100 to grasp and lift the object O.

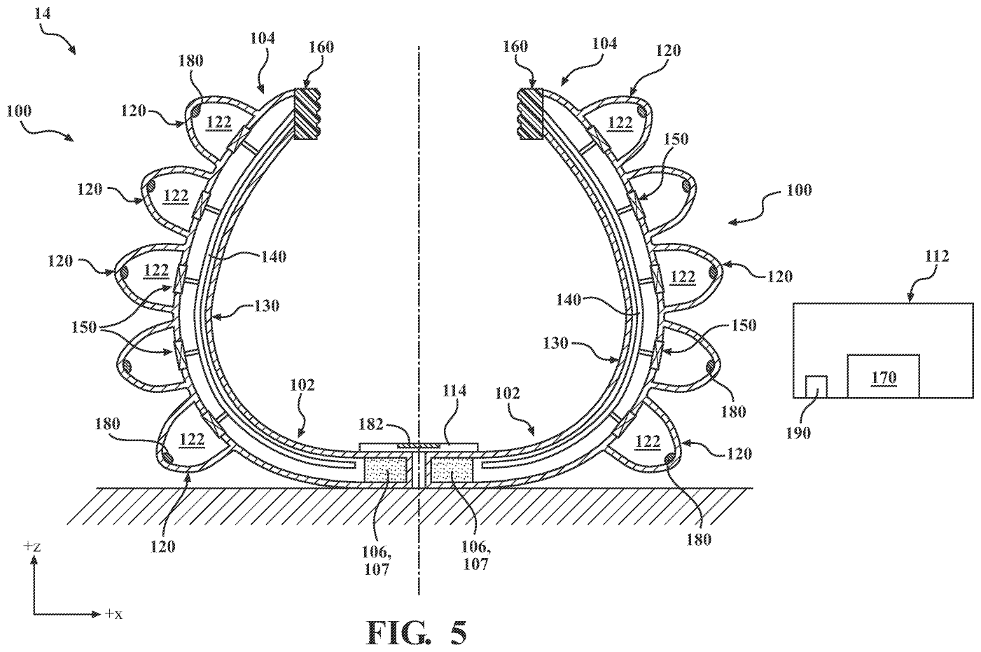

Referring now to FIG. 5, a soft actuator 14 according to still another form of the present disclosure includes the actuator arms 100 as described above and included here by reference, but not repeated. However, instead of the proximal ends 102 of actuator arms 100 being attached to and/or supported by the base 110 as illustrated in FIG. 1, or the proximal ends 102 overlapping each other and being interlocked as illustrated in FIG. 3, each of the proximal ends 102 with the magnet 106 and/or the magnetic fabric 107 are aligned generally planar (x-y plane shown in the figures) to each other and a jamming sheet 112 that interlocks the proximal ends 102 to each other is included. That is, the jamming sheet 112 applies force onto (−z direction) the proximal ends 102 shown in FIG. 5 such that the proximal ends 102 are securely interlocked with each other and positioned relative to the surface ‘S’, and do not appreciably move during operation of the soft actuator 14. In the alternative, the proximal ends 102 can be positioned on the base 110 (not shown).

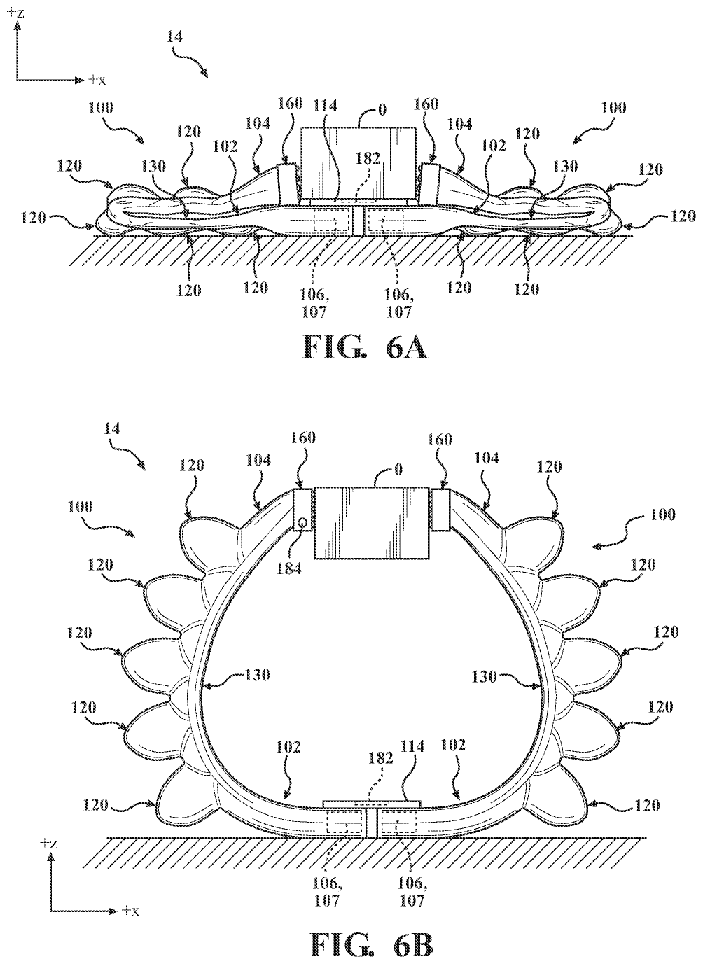

Referring to FIGS. 6A-6B, one example of the soft actuator 14 during operation is shown. Particularly, the object O in a first position is shown in FIG. 6A and the object O lifted to a desired second position is shown in FIG. 6B. In the first position, the object is located on the proximal ends 102 and the actuator arms 100 are in a generally uninflated state. In addition, the object is positioned on the load sensor 182, and the load sensor 182 transmits a signal proportional to the mass or weight of the object O to the controller 190 (FIG. 5). The controller 190 receives input (e.g., from an individual, another sensors, and/or another controller) regarding the desired second position, receives the transmitted signal from the load sensor 182, and then determines (e.g., via a look up table and/or algorithm) which of the pouches 120 to be inflated and/or to want extent (e.g., pressure) the pouches 120 are to be inflated in order to move the object O from the first position to the desired second position above (+z direction) the first position. The controller 190 also commands the inflating device 170 (FIG. 3) to provide pressurized fluid to the fluid channel 140 and commands selected valves 150 to be in an open position or in a closed position such that the pouches 120 are selectively inflated and/or deflated to a desired pressure and the object O is lifted from the first position to the desired second position. And in some variations a position sensor 184 configured to provide a position signal of a predefined location of one or both of the actuator arms 100 (e.g., a position of one of the grippers 160) to the controller 190 is included such that a current position of the object O is determined and/or monitored. For example, in such variations the controller 190 is configured to receive the position signal from the position sensor 184 and command the inflating device 170 and/or one or more of the valves 150 such that the pouches 120 are selectively inflated and/or deflated to a desired pressure and the object O is lifted to a desired height and/or maintained at the desired height.

In some variations, the design, shape, and/or structure of the soft actuator 14 is such that the grippers 160 are in contact with the object O is in the first position. In other variations, the design, shape, and/or structure of the soft actuator 14 is such that the grippers 160 are brought into contact with the object O during pumping of the fluid into the fluid channel 140 such that the distal ends 104 with the grippers 160 move towards (+/−directions) each other. In the alternative, or in addition to, the design, shape, and/or structure of the soft actuator 10 is such that the grippers 160 are brought into contact with the object O during pumping the fluid into one or more of the pouches 120 such that the distal ends 104 with the grippers 160 move towards each other. And while FIG. 6A illustrates the object O positioned directly on the proximal ends 102 (i.e., on directly on the jamming sheet 112 that is on the proximal ends 102), in some variations the object O is positioned above (i.e., spaced apart from) the proximal ends 102 before being grasped by the grippers 160. For example, the object O can be held or positioned by an individual or a machine at a predefined distance above (+z direction) the proximal ends 102 before being grasped by the grippers 160. In addition, in some variations the soft actuator 14 includes only one actuator arm 100 with a mechanical, electrical and/or electro-mechanical attachment device (e.g., a hook, latch, and/or a magnet) to grasp and lift the object O, or more than two actuator arms 100 to grasp and lift the object O.

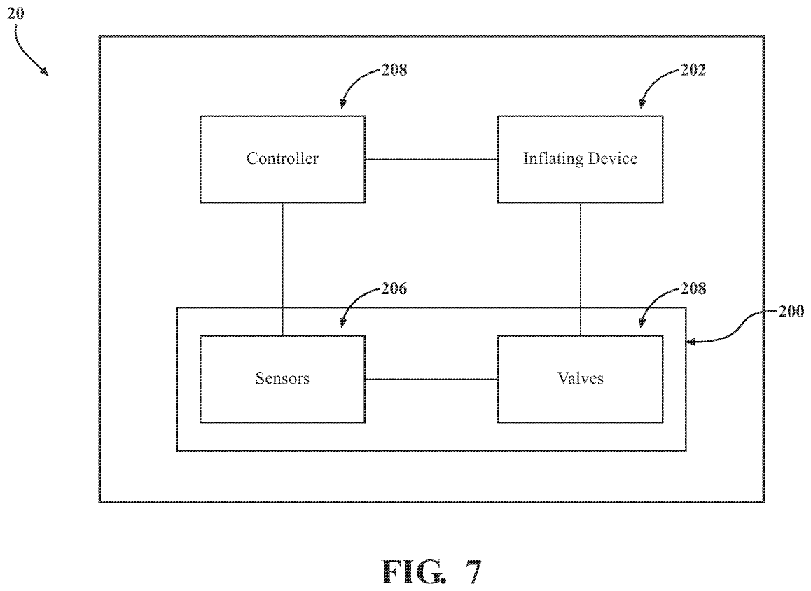

Referring now to FIG. 7, a block diagram of a soft actuator system 20 according to the teachings of the present disclosure is shown. The soft actuator system 20 includes a soft actuator 200 at least one soft actuator arm (not shown) with a plurality of inflatable pouches (not shown), a fluid channel (not shown) in fluid communication with the plurality of inflatable pouches, an inflating device 202 in fluid communication with the fluid channel, one or more valves 204 in fluid communication with the fluid channel and the plurality of inflatable pouches, one or more sensors 206, and a controller 208. During operation, the controller 208 receives signals from the sensors (e.g., as described above), and based on or as a function of the signals received from the sensors 206, commands the inflating device 202 and the valves 204 such that the plurality of inflatable pouches are selectively and desirably inflated. In this manner, an object can be moved by the soft actuator 200 from a first position to one or more second positions.

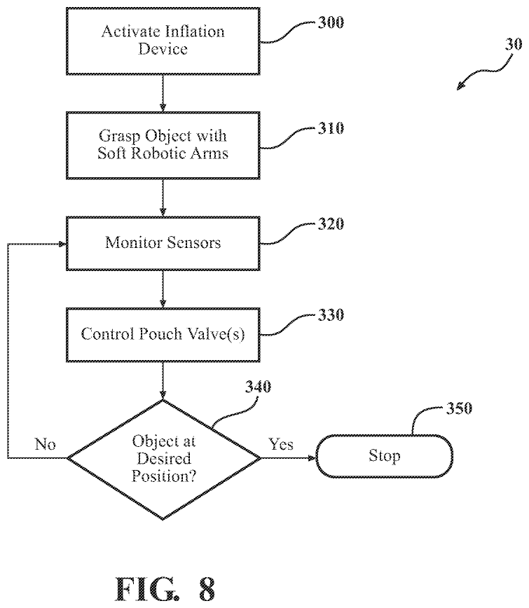

Referring to FIG. 8, a flowchart for a method 30 of moving an object from a first position to a second position using a soft actuator and/or a soft actuator system according to the teachings of the present disclosure is shown. The method 30 includes activating an inflating device at 300 and grasping the object with a soft actuator at 310. The soft actuator includes a plurality of pouches, one or more valves and one or more sensors as described above. The method 30 includes monitoring the sensors at 320 and controlling the valves at 330. At 340, the method 30 determines whether the object is at a desired position. If the object is not at a desired position, the method 30 returns to 320 and 330 where the sensors are monitored and the valves are controlled. This cycle (i.e., 320-330-340-320) continues until the object is moved to the desired position.

The preceding description is merely illustrative in nature and is in no way intended to limit the disclosure, its application, or its uses. Work of the presently named inventors, to the extent it may be described in the background section, as well as aspects of the description that may not otherwise qualify as prior art at the time of filing, are neither expressly nor impliedly admitted as prior art against the present technology.

The block diagram in the figures illustrates the architecture, functionality, and operation of possible implementations of systems, methods, and computer program products according to various embodiments. In this regard, each block in the block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, devices, processes, and/or controllers described above can be realized in hardware or a combination of hardware and software and can be realized in a centralized fashion in one processing system or in a distributed fashion where different elements are spread across several interconnected processing systems. Any kind of processing system or another apparatus adapted for conducting the methods described herein is suited. A typical combination of hardware and software can be a processing system with computer-usable program code that, when being loaded and executed, controls the processing system such that it conducts the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to conduct these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for the general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The terms “a” and “an,” as used herein, are defined as one or more than one. The term “plurality.” as used herein, is defined as two or more than two. The term “another,” as used herein, is defined as at least a second or more. The terms “including” and/or “having.” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation or particular system is included in at least one variation or form. The appearances of the phrase “in one variation” (or variations thereof) are not necessarily referring to the same variation or form. It should also be understood that the various method steps discussed herein do not have to be conducted in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A soft actuator comprising:
an inflatable arm comprising:
a plurality of inflatable pouches;
a common fluid channel in fluid communication with and configured to provide a pressurized fluid to the plurality of inflatable pouches;
a plurality of valves in fluid communication with the common fluid channel and the plurality of inflatable pouches; and
at least one sensor in communication with at least one of the plurality of inflatable pouches such that the common fluid channel, the plurality of valves and the at least one sensor are configured to selectively inflate the plurality of inflatable pouches.

2. The soft actuator according to claim 1 further comprising a controller configured to command the plurality of valves such that the plurality of inflatable pouches are selectively inflated.

3. The soft actuator according to claim 2, wherein the at least one sensor is in communication with and configured to transmit a sensor signal to the controller, the controller configured to receive the sensor signal and command the plurality of valves as a function of the sensor signal.

4. The soft actuator according to claim 3 further comprising an inflation device in fluid communication with and configured to provide the pressurized fluid to the common fluid channel, wherein the controller is configured to command the inflation device as a function of the sensor signal.

5. The soft actuator according to claim 2, wherein the at least one sensor comprises a position sensor configured to determine a position of a predefined location on the inflatable arm and transmit a position signal to the controller.

6. The soft actuator according to claim 5, wherein the controller is configured to command at least one of the plurality of valves as a function of the position signal.

7. The soft actuator according to claim 6 further comprising an inflation device in fluid communication with and configured to provide the pressurized fluid to the common fluid channel, wherein the controller is configured to command the inflation device as a function of the position signal.

8. The soft actuator according to claim 2, wherein the at least one sensor comprises a pressure sensor configured to determine a pressure within at least one of the plurality of inflatable pouches and transmit a pressure signal to the controller.

9. The soft actuator according to claim 8, wherein the controller is configured to command at least one of the plurality of valves as a function of the pressure signal.

10. The soft actuator according to claim 9 further comprising an inflation device in fluid communication with and configured to provide the pressurized fluid to the common fluid channel, wherein the controller is configured to command the inflation device as a function of the pressure signal.

11. The soft actuator according to claim 2, wherein the at least one sensor comprises a load sensor configured to determine a load supported by the inflatable arm and transmit a load signal to the controller.

12. The soft actuator according to claim 11, wherein the controller is configured to command at least one of the plurality of valves as a function of the load signal.

13. The soft actuator according to claim 12 further comprising an inflation device in fluid communication with and configured to provide the pressurized fluid to the common fluid channel, wherein the controller is configured to command the inflation device as a function of the load signal.

14. The soft actuator according to claim 2, wherein the at least one sensor is a plurality of pressure sensors individually in communication with and individually configured to transmit a pressure signals to the controller, the controller configured to receive a plurality of pressure signals from the plurality of pressure sensors and command the plurality of valves as a function of the plurality of pressure signals such that the plurality of inflatable pouches are selectively inflated.

15. A soft actuator comprising:
an inflatable arm comprising:
a plurality of inflatable pouches;
a common fluid channel in fluid communication with and configured to provide a pressurized fluid to the plurality of inflatable pouches;
a plurality of valves in fluid communication with the common fluid channel and the plurality of inflatable pouches;
a plurality of sensors in communication with at least a subset of the plurality of inflatable pouches such that the common fluid channel, the plurality of valves and the plurality of sensors are configured to selectively inflate the plurality of inflatable pouches; and
a controller configured to command the plurality of valves such that the plurality of inflatable pouches are selectively inflated.

16. The soft actuator according to claim 15 further comprising an inflation device in fluid communication with and configured to provide the pressurized fluid to the common fluid channel, wherein the controller is configured to command the inflation device as a function of a plurality of sensor signals from the plurality of sensors.

17. The soft actuator according to claim 16, wherein the plurality of sensors comprise a plurality of pressure sensors configured to determine a pressure within the at least the subset of the plurality of inflatable pouches and transmit a plurality of pressure signals to the controller.

18. The soft actuator according to claim 17, wherein the controller is configured to command at least one of the plurality of valves as a function of the plurality of pressure signals.

19. A soft actuator comprising:
an inflatable arm comprising:
a plurality of inflatable pouches;
a common fluid channel in fluid communication with and configured to provide a pressurized fluid to the plurality of inflatable pouches;
a plurality of valves in fluid communication with the common fluid channel and the plurality of inflatable pouches;
a plurality of sensors in communication with at least a subset of the plurality of inflatable pouches such that the common fluid channel, the plurality of valves and the plurality of sensors are configured to selectively inflate the plurality of inflatable pouches;
an inflation device in fluid communication with and configured to provide a pressurized fluid to the common fluid channel; and
a controller configured to command the plurality of valves such that the plurality of inflatable pouches are selectively inflated.

20. The soft actuator according to claim 19, wherein the plurality of sensors comprise:
a plurality of pressure sensors configured to determine a pressure within the plurality of inflatable pouches and transmit a plurality of pressure signals to the controller; and
at least one load sensor configured to determine a load supported by the inflatable arm and transmit a load signal to the controller.
